(19) United States
(12) Patent Application Publication
(10) Pub. No.: US 2024/0157847 A1
(43) Pub. Date: May 16, 2024

(54) Battery Balancing

(71) Applicant: Ariens Company, Brillion, WI (US)

(72) Inventors: Michael J. Holeton, Kaukauna, WI (US); William Tenorio, Woodridge, IL (US); Kristopher M. Kommes, De Pere, WI (US)

(21) Appl. No.: 18/551,971

(22) PCT Filed: Mar. 1, 2022
(86) PCT No.: PCT/US22/18334

§ 371 Date: Sep. 22, 2023

Related U.S. Application Data
(60) Provisional application No. 63/166,528, filed on Mar. 26, 2021.

(51) Int. Cl. B60L 58/22; B60L 58/13; B60L 58/21

(52) U.S. Cl. CPC B60L 58/22; B60L 58/13; B60L 58/21; B60L 2200/40; B60L 2210/10; B60L 2250/16

(57) ABSTRACT

A battery balancing method for balancing voltages of battery packs on a bus bar of a utility vehicle is disclosed. The method includes determining, by a control system, a state of charge for a first battery pack and a second battery pack of the utility vehicle, initiating converter battery balancing, by the control system, to discharge the first battery pack to the second battery pack through a DC-to-DC converter in response the first battery pack having a state of charge that is more than a first threshold amount above a state of charge of the second battery pack, and initiating direct battery balancing, by the control system, to discharge the first battery pack to the second battery pack in response to the first battery pack having a state of charge that is less than the first threshold amount above the state of charge of the second battery pack.

### CROSS-REFERENCE TO RELATED APPLICATIONS

The present application is related to and claims benefit under 35 U.S.C. § 119(e) from U.S. Provisional Patent Application Ser. No. 63/166,528, filed Mar. 26, 2021, entitled “Battery Balancing” the entire contents of which being incorporated herein by reference.

### FIELD OF THE INVENTION

The present invention relates to a battery balancing systems and method for battery packs of a utility vehicle.

### SUMMARY

Embodiments of the battery balancing systems and methods described herein relate to battery balancing for battery packs that are connected to a utility vehicle, such an electric zero-turn mower, a tractor, and a snow thrower. Unregulated charge transfer between high power battery packs can lead to high current transfer that can damage the battery packs. To regulate and ensure safe energy transfer between battery packs of the utility vehicle, a control system initiates and controls battery balancing of the battery packs based on characteristics of the battery packs.

In one aspect, the invention provides a battery balancing method for balancing voltages of battery packs on a bus bar of a utility vehicle, the method comprising: determining, by a control system including at least one electronic controller, a state of charge for a first battery pack and a second battery pack of the utility vehicle; initiating converter battery balancing, by the control system, to discharge the first battery pack to the second battery pack through a DC-to-DC converter in response the first battery pack having a state of charge that is more than a first threshold amount above a state of charge of the second battery pack; and initiating direct battery balancing, by the control system, to discharge the first battery pack to the second battery pack in response to the first battery pack having a state of charge that is less than the first threshold amount above the state of charge of the second battery pack.

In another aspect, the invention provides a battery balancing and notification method for a utility vehicle, the method comprising: initiating, by a control system including at least one electronic controller, battery balancing between a first battery pack and a second battery pack on the utility vehicle that are coupled by a bus bar including a communication line and a power line; providing a communication, by the control system, to a user display of the utility vehicle that is indicative of the performance of battery balancing; and displaying, in response to the communication, a message on the user display of the utility vehicle that the battery balancing is being performed.

In another aspect, the invention provides a battery balancing method for balancing voltages of battery packs on a bus bar of a utility vehicle. The method comprising: determining, by a control system including at least one electronic controller, a state of charge for each battery pack of three or more battery packs of the utility vehicle; determining, by the control system, a first battery pack having a highest state of charge of the three or more battery packs and a second battery pack having a second highest state of charge of the three or more battery packs; initiating converter battery balancing, by the control system, to discharge the first battery pack to each other battery pack of the three or more battery packs through a DC-to-DC converter in response to at least one selected from the group of: the first battery pack having a state of charge that is more than a first threshold amount above a state of charge of the second battery pack, and the first battery pack having a state of charge that is within a second threshold amount of a state of charge of the second battery pack; and initiating direct battery balancing, by the control system, to discharge the first battery pack to the second battery pack in response to the first battery pack having a state of charge that is between the first threshold amount and the second threshold amount above the state of charge of the second battery pack.

In another aspect, the invention provides a utility vehicle comprising: a frame; a drive wheel supporting the frame above a ground surface; a drive motor mounted to the frame and driving rotation of the drive wheel to move the utility vehicle over the ground surface; an operator platform supported by the frame, and operable to support the weight of a user during operation of the utility vehicle; a utility device coupled to the frame; two or more battery packs electrically connected to a bus bar and supported by the frame; and a control system including at least one electronic controller, the control system in communication with the drive motor, the utility device, and the two or more battery packs. The control system configured to: determine a state of charge for a first battery pack and a second battery pack of the utility vehicle; initiate converter battery balancing to discharge the first battery pack to the second battery pack through a DC-to-DC converter in response the first battery pack having a state of charge that is more than a first threshold amount above a state of charge of the second battery pack; and initiate direct battery balancing to discharge the first battery pack to the second battery pack in response to the first battery pack having a state of charge that is less than the first threshold amount above the state of charge of the second battery pack.1

In another aspect, the invention provides, a utility vehicle comprising: a frame; a drive wheel supporting the frame above a ground surface; a drive motor mounted to the frame and driving rotation of the drive wheel to move the utility vehicle over the ground surface; an operator platform supported by the frame, and operable to support the weight of a user during operation of the utility vehicle; a utility device coupled to the frame; two or more battery packs electrically connected to a bus bar and supported by the frame; a user display supported by the frame proximate the operator platform; and a control system including at least one electronic controller, the control system in communication with the drive motor, the utility device, the two or more battery packs, and the user display. The control system configured to: initiate battery balancing between a first battery pack and a second battery pack coupled to the bus bar of the utility vehicle; and provide a communication to the user display of the utility vehicle that is indicative of the performance of the battery balancing, wherein a message is displayed on the user display of the utility vehicle in response to the communication from the control system, that the battery balancing is being performed.

In another aspect, the invention provides a utility vehicle comprising: a frame; a drive wheel supporting the frame above a ground surface; a drive motor mounted to the frame and driving rotation of the drive wheel to move the utility vehicle over the ground surface; an operator platform supported by the frame, and operable to support the weight of a user during operation of the lawn mower; a utility device coupled to the frame; three or more battery packs electrically connected to a bus bar and supported by the frame; and a control system including at least one electronic controller, the control system in communication with the drive motor, the utility device, and the three or more battery packs. The control system configured to: determine a state of charge for each battery pack of three or more battery packs of the utility vehicle; determine a first battery pack having a highest state of charge of the three or more battery packs and a second battery pack having a second highest state of charge of the three or more battery packs, initiate converter battery balancing to discharge the first battery pack to each other battery pack of the three or more battery packs through a DC-to-DC converter in response to at least one selected from the group of: the first battery pack having a state of charge that is more than a first threshold amount above a state of charge of the second battery pack, and the first battery pack having a state of charge that is within a second threshold amount of a state of charge of the second battery pack; and initiate direct battery balancing, by the control system, to discharge the first battery pack to the second battery pack in response to the first battery pack having a state of charge that is between the first threshold amount and the second threshold amount above the state of charge of the second battery pack.

Other aspects of the invention will become apparent by consideration of the detailed description and accompanying drawings.

### BRIEF DESCRIPTION OF THE DRAWINGS

FIG. 1 is a perspective view of an electric zero turn lawn mower.

FIG. 2 is another perspective view of the lawn mower of FIG. 1.

FIG. 3 is a bottom perspective view of the lawn mower FIG. 1.

FIG. 4 is a perspective view of a battery compartment of the lawn mower of FIG. 1 having a bank of batteries positioned within the battery compartment.

FIG. 5 is a perspective view of the battery compartment of the lawn mower of FIG. 1 having the bank of batteries removed from the battery compartment to illustrate a battery attachment structure.

FIG. 6 is a bottom perspective view of the battery compartment of the lawn mower of FIG. 1 illustrating the bus bar.

FIG. 7 is a block diagram of the lawn mower of FIG. 1 according to an embodiment of the disclosure.

FIG. 8 is a block diagram of the battery packs attached to the bus bar of the lawn mower of FIG. 1.

FIG. 9 is a flow chart illustrating a battery balancing method according to an embodiment of the disclosure.

FIG. 10 is a flow chart illustrating a battery balancing method according to an embodiment of the disclosure.

FIG. 11 is a diagram illustrating control logic for the battery balancing method of FIG. 10.

FIG. 12 is a diagram illustrating state of charge of the battery packs during the battery balancing method of FIG. 10.

FIG. 13 is a flow chart illustrating a battery balancing and notification method according to an embodiment of the disclosure.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. As used herein, terms relating to position (e.g., front, rear, left, right, etc.) are relative to an operator situated on a utility vehicle during normal operation of the utility vehicle.

The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not explicitly listed.

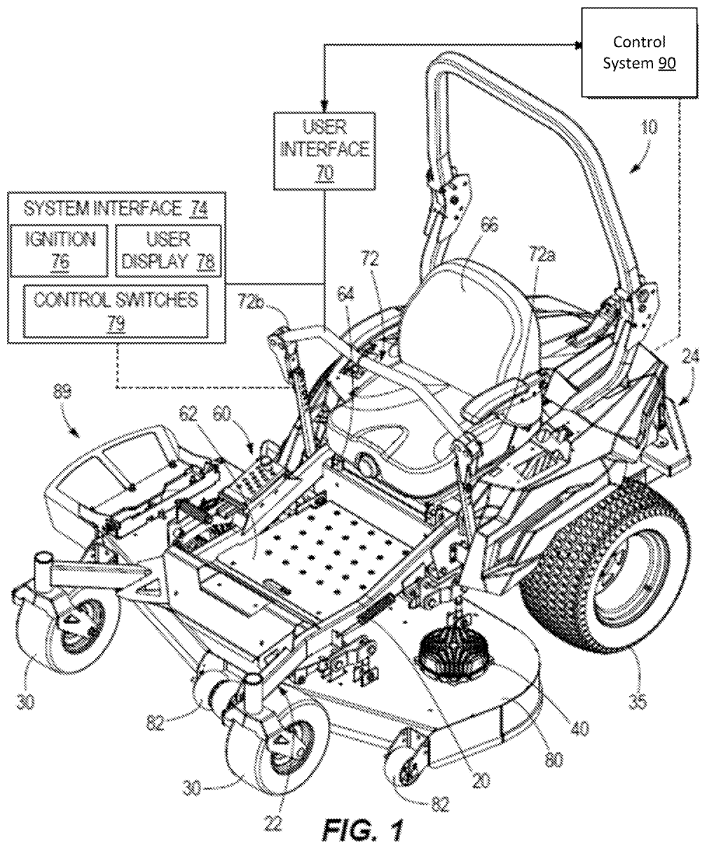

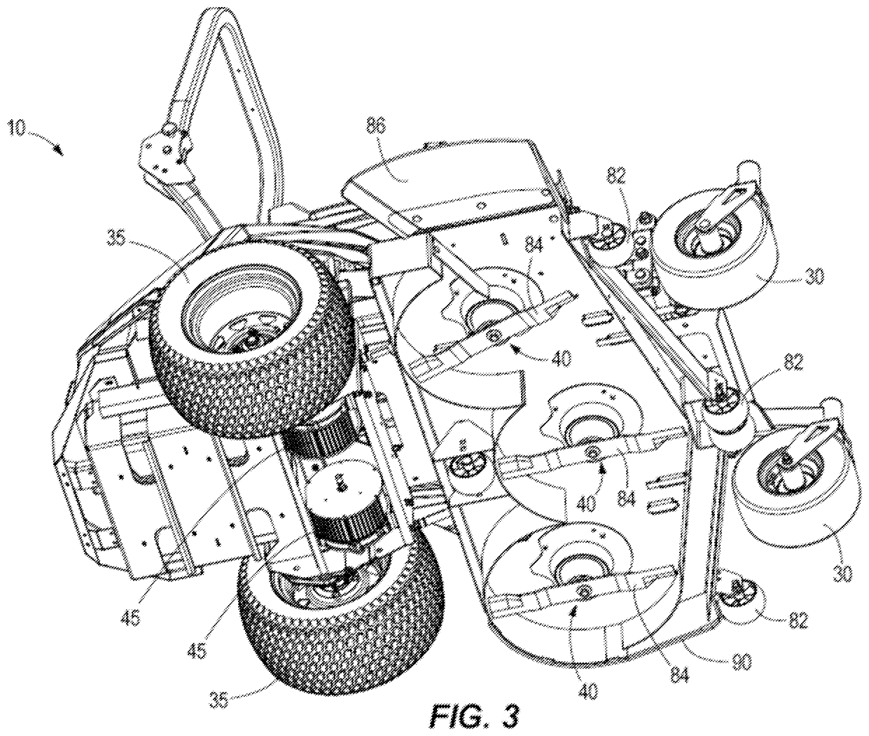

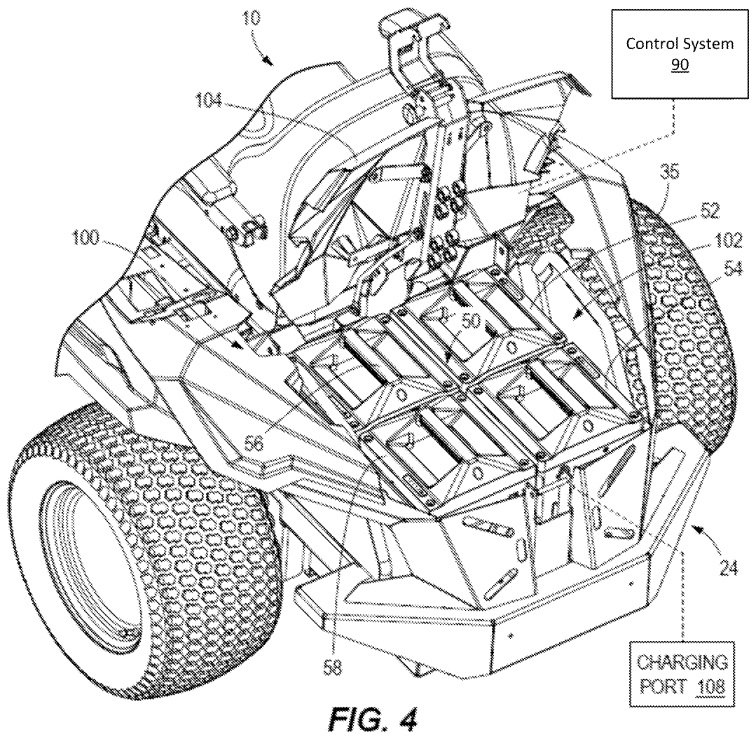

FIGS. 1-4 illustrate a utility vehicle 10. The utility vehicle 10 may be, for example, an electric zero-turn lawn mower, a hybrid lawn mower. The illustrated utility vehicle 10 includes a frame 20, ground engaging elements 30, 35, a prime mover 40, 45 (FIGS. 1 and 3), a power source 50 (FIG. 4), an operator platform 60, a user interface 70 (illustrated schematically in FIG. 1), a utility device such as cutting deck 80, and a vehicle control system 90 (illustrated schematically in FIG. 1). While the utility vehicle 10 is described below as an electric zero-turn mower, it should be appreciated that the utility vehicle may be vehicles such as a ride-on tractor, a stand-on mower, a snow thrower, a push mower, or the like. Such utility vehicles may include a utility device such as a cutting deck, a snow auger, and the like.

The frame 20 includes a first or front portion 22 (extending to the center of the frame) and a second or rear portion 24 (meeting the front portion at the center of the frame) opposite the front portion 22. The frame 20 defines the basic body structure or chassis of the lawn mower 10 and supports the other components of the lawn mower 10. The frame 20 is supported by the ground engaging elements 30, 35 and in turn supports the other components of the lawn mower 10.

The ground-engaging elements 30, 35 are movably (e.g., rotatably) coupled to the frame 20. The illustrated ground-engaging elements 30, 35 include two first or front ground-engaging elements 30 coupled to the front portion 22 of the frame 20, and two second or rear ground-engaging elements 35 coupled to the rear portion 24 of the frame 20. In the illustrated embodiment, the ground-engaging elements 30, 35 are rotatable wheels but, in other embodiments, could be tracks, for example. In the illustrated embodiment, the first (front) ground-engaging elements 30 are passive (i.e., rotating in response to movement of the lawn mower) caster wheels and the second (rear) ground-engaging elements 35 are the driven (i.e., rotating to cause movement of the lawn mower) wheels rotating under the influence of the prime mover 45. The second (rear) ground-engaging elements 35 may be referred to in the illustrated embodiment as the drive wheels or the left and right drive wheels 35, it being understood that the terms “left” and “right” are from the perspective of an operator in an ordinary operating position on the lawn mower. The drive wheels 35 are rotated by the prime mover 45 at a selected speed and direction to effect movement and steering of the lawn mower 10 in the well-known manner of a zero turn radius lawn mower. In other embodiments, similar prime movers 45 may also or alternatively be coupled to the two first ground-engaging elements 30 for the same purpose as the prime movers 45. In other embodiments, the lawn mower may take the form of a stand-on mower or a tractor-style mower with steerable wheels.

The prime mover 40, 45 may, for example, be one or more electric motors, hybrid gas/electric source, etc. With reference to FIGS. 1-3, the prime mover 40, 45 of the illustrated embodiment includes a plurality of prime movers in the form of dedicated drive motors 45 (FIG. 3) and deck motors 40. The drive motors 45 are supported by the frame 20, and are interconnected to the drive wheels 35 through a transmission or gear train to increase speed or torque delivered to the drive wheels 35. In an alternative embodiment, the drive motors 45 may each include an output shaft that is directly coupled to one of the drive wheels 35 to independently drive rotation of the associated drive wheel 35 at a selected speed and direction. The drive wheels 35 of this alternative embodiment may, therefore, be characterized as direct-drive wheels with dedicated drive motors 45. Speed and steering of the mower in the illustrated embodiment are effected by the direction and relative speeds of the drive wheels 35. To elaborate further on the point made earlier, the deck motors 40 and drive motors 45 together make up what is referred to as the prime mover of the illustrated lawn mower 10. In the illustrated embodiment a deck motor 40 is dedicated to each blade and a drive motor 45 is dedicated to each drive wheel 35; but, in other embodiments, the work of some or all of these motors 40, 45 can be combined in a single motor that distributes torque to multiple blades and/or drive wheels through power transmissions.

Turning now to FIG. 4, the power source 50 in the illustrated embodiment is a bank (plurality) of battery packs 52, 54, 56, 58, as described in detail below. The battery packs 52, 54, 56, 58 may have a voltage of approximately 52V. In other embodiments, the battery packs 52, 54, 56, 58 may have a voltage that is greater than or less than 52V. In other embodiments, the power source 50 may include a two relatively larger batteries than the four battery packs 52, 54, 56, 58 illustrated, but, one potential advantage of the illustrated embodiment is that the battery packs 52, 54, 56, 58 are modular, lighter, and independently chargeable. In some embodiments, the power source 50 includes more than four battery packs.

The illustrated battery packs 52, 54, 56, 58 can be handled, carried, charged, replaced, and serviced more easily by a typical user than a single, much larger battery. For example, the illustrated batteries may weigh approximately 55 lbs. or less apiece, as discussed below. In some embodiments, the batteries may weigh 53 lbs. The power source 50 is electrically coupled to the drive motors 45 and deck motors 40 to provide sufficient power for their operation. The power source 50 is illustrated as being supported in the rear portion 24 of the frame 20; but, in other embodiments, may be supported on the front portion 22 or in the center of the frame 20 (straddling the front and rear portions 22, 24 of the frame 20).

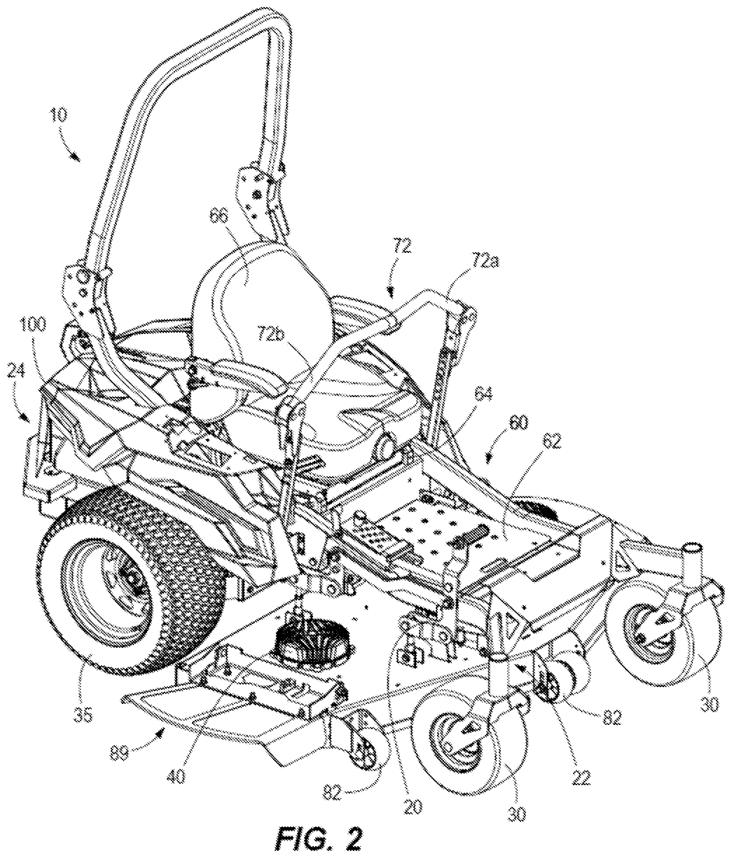

With reference to FIGS. 1 and 2, the operator platform 60 is supported by the frame 20 and straddles the front portion 22 and the rear portion 24 of the frame 20. The illustrated operator platform 60 includes a first or lower section 62 and a second or upper section 64. The lower section 62 is located forward of the upper section 64 and is configured to support a user's feet. The upper section 64 is located rearward of the lower section 62 and supports a seat 66. The seat 66 allows a user to sit during operation of the lawn mower 10 and access the user interface 70. In some embodiments, the operator platform 60 may only include the lower section 62 such that the lawn mower 10 is a standing vehicle. In further embodiments, the operator platform 60 may have other configurations. An operator zone is defined as the seat 66 and all of the controls and other elements of the lawn mower 10 that can be reached by or seen by the user while seated, such as the user interface 70 and the lower portion 62.

The user interface 70 (schematically illustrated in FIG. 1) includes maneuvering controls 72 and a system interface 74 supported by the frame 20 within the operator zone. The maneuvering controls 72 are operable to control the lawn mower 10, for example, by providing drive commands in response to user manipulation of the maneuvering controls 72. For example, the maneuvering controls 72 can be used to control the drive motors 45 to drive a desired speed and direction of rotation of the rear ground-engaging elements 35 to move and/or turn the lawn mower 10. In the illustrated embodiment, the maneuvering controls 72 include left and right control arms 72a, 72b used for a zero-turn radius (ZTR) lawn mower. The drive motors 45 are manipulated with the left and right control arms 72a, 72b, with the left control arm 72a controlling the direction and speed of rotation of the left drive wheel 35 and the right control arm 72b controlling the direction and speed of rotation of the right drive wheel 35. In the illustrated embodiment, the left control arm 72a is coupled to the frame 20 at a pivot joint 73a and the right control arm 72b is coupled to the frame 20 at a pivot joint 73b. In other embodiments, the maneuvering controls 72 may include other suitable actuators, such as a steering wheel, joystick(s), and the like.

The system interface 74 may include an ignition 76, a user display 78, and control switches 79 (e.g., adjustment switches in the form of dials, push buttons, etc.). The ignition 76 communicates with the vehicle control system 90 to allow the user to selectively provide power to (i.e., activate) the drive motors 45 and the deck motors 40. In some embodiments, ignition 76 include separate switches that activate the drive motors 45 and the deck motors 40 independently or by group. In the illustrated embodiment, the battery packs 52, 54, 56, 58 communicate directly with the user display 78 (e.g., via CAN communication) to display battery-related information on the user display 78. For example, the user display 78 may display a state of charge of the power source 50, faults occurring on the mower (e.g., battery pack faults), an operational state of the lawn mower 10, etc. The control switches 79 and the user display 78 may interact with the vehicle control system 90 to control functions of the mower 10 (e.g., activation of deck motor 40, drive motors 45, etc.).

With reference to FIG. 3, the cutting deck 80 is supported underneath the frame 20 mainly in the front portion 22 in the illustrated embodiment, but in other embodiments might be moved rearward to the center or even fully to the rear portion 24, for example. The cutting deck 80 includes one or more ground-engaging elements 82 (e.g., anti-scalping rollers) that support the cutting deck 80 on the ground. As illustrated in FIGS. 1 and 2, the deck motors 40 are mounted to the cutting deck 80. In the illustrated embodiment, the cutting deck 80 includes three deck motors 40. In other embodiments, the cutting deck 80 may include fewer deck motors 40 (e.g., one or two) or more deck motors 40 (e.g., three, four, etc.). Referring back to FIG. 3, each deck motor 40 is mounted at least partially above the cutting deck 80 to provide access to cooling ambient air and includes an output shaft under the cutting deck 80. A blade 84 is mounted under the cutting deck 80 to each output shaft and rotates under the influence of the deck motor 40 to cut grass under the cutting deck 80. In the illustrated embodiment, the cutting deck 80 includes a side discharge opening 89 to discharge mown grass. In other embodiments, the cutting deck 80 may include a rear discharge, a collection bag, etc. to collect or discharge mown grass from under the cutting deck 80. In other embodiments, the blades 84 may be configured to mulch the grass clippings in which case there may be no discharge opening 89 or the discharge opening 89 may include a mechanism for opening and closing to selectively provide discharge and mulching functionality. Each of the deck motors 40 directly drives a single blade 84 and can therefore be termed a direct-drive, dedicated deck motor 40.

The vehicle control system 90 may interact with the user interface 70, the drive motors 45 (e.g., via a drive motor controller), and the deck motors 40 (e.g., via a deck motor controller). More specifically, the vehicle control system 90 may take input from the system interface 74 and relay instructions to the drive motors 45 and the deck motors 40. The vehicle control system 90 may also receive information from the power source 50, such as state of charge of the batteries and other battery-related information, and relay this information to the user interface 70. The user display 78 may display information to the user such as state of charge of the power source 50, operation mode of mower 10, etc., as described in more detail below. While lawn mower 10 is described above as an electric zero turn lawn mower, it should be appreciated that the battery assembly and/or control systems described below may be used with any utility device that is operable to cut grass or other utility vehicles such as snow throwers.

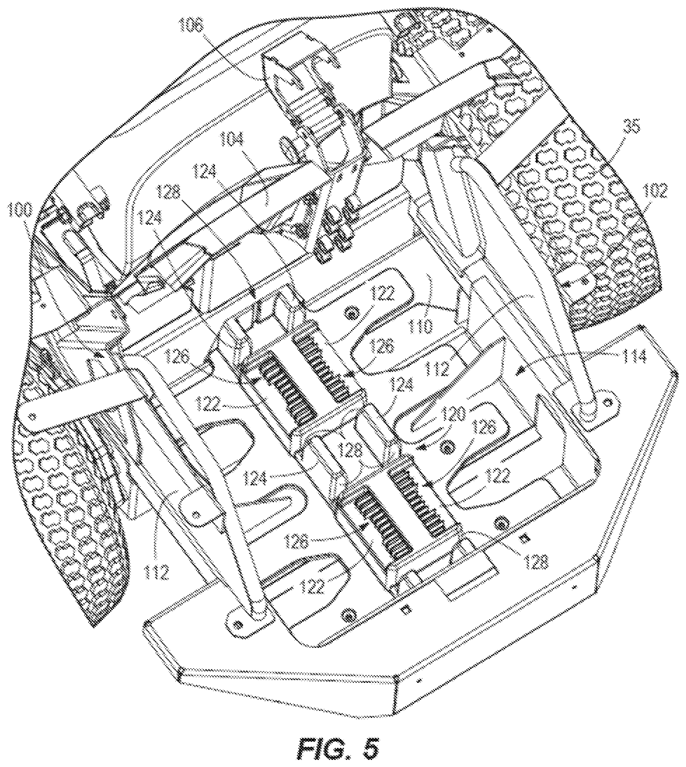

Now referring to FIGS. 4 and 5, a battery compartment 100 is supported by the frame 20. The battery compartment 100 includes a housing 102, a lid 104, a latch 106 and a charging port 108 (illustrated schematically). The housing 102 has a bottom wall 110 and side walls 112 and defines an opening 114. The lid 104 is coupled to the housing 102 and is movable between a closed condition (FIGS. 1-2) in which it covers the opening 114 (i.e., closes the housing 102) and an open condition (FIGS. 4-5) in which it provides access to the opening 114 (i.e., opens the housing 102). In the illustrated embodiment, the lid 104 is pivotally (more specifically, hingedly) coupled to the forward end of the housing 102. The latch 106 selectively secures the lid 104 in the closed condition. Although illustrated schematically, the charging port 108 may, for example, be mounted to or integrated into the housing 102 of the battery compartment 100. In other embodiments the charging port 108 can be provided separately from the housing 102.

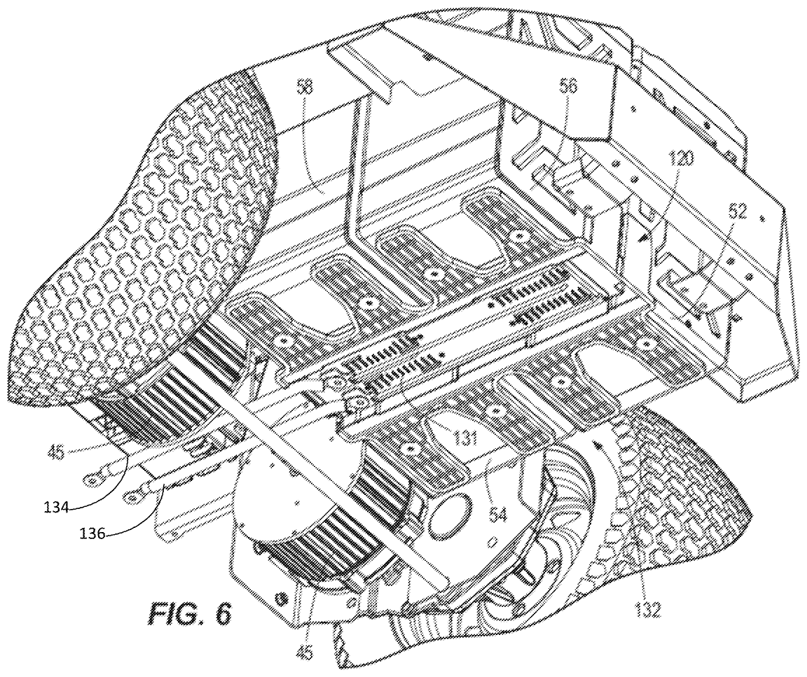

Referring now to FIGS. 5 and 6, an example battery interface 120 is mounted to the bottom wall 110 of the battery compartment 100. The battery interface 120 includes four docking stations 122, each including alignment structures 124 and electrical connectors 126. The electrical connectors 126 are between alignment structures 124. Within (e.g., between the alignment structures 124 and electrical connectors 126) and between each docking station 122 are slits 128 to allow debris to exit the battery compartment 100 to reduce the likelihood of debris buildup. In other embodiments, the battery interface 120 may include more docking stations 122 (e.g., five, six, etc.) or fewer docking stations 122 (e.g., three, two, one).

As illustrated in FIG. 6, a bus bar 131 is mounted to a bottom side 132 of the battery interface 120 and independently attaches to each of the battery packs 52, 54, 56, 58 via the electrical connectors 126 of respective docking stations 122. The bus bar 131 includes positive and negative power lines 134, 136, which are configured to provide a connection from the battery packs 52, 54, 56, 58 to the deck and drive motors 40, 45, at least indirectly, and are shown extending away for the bus bar 131 (disconnected). In some embodiments, the bus bar 131 may also include one or more communication lines that connects the bus bar 131 to the control system 90 or that connect the control system 90 (e.g., when integrated into one or more of the battery packs 52, 54, 56, 58) to other components of the mower 10 (e.g., the system interface 74 including the user display 78). In some embodiments, the communication lines are part of a controller area network (CAN) bus of the mower 10 implementing a message-based protocol allowing communications between multiple components including, for example, the battery packs 52, 54, 56, 58, the system interface 74, the control system 90 (and controllers thereof).

The battery interface 120 is adapted to receive a plurality of battery packs 52, 54, 56, 58, which together are referred to as a bank of battery packs 50. In the illustrated embodiment, the bank of battery packs 50 includes four battery packs 52, 54, 56, 58 to match the four docking stations 122 of the battery interface 120. Each of the battery packs 52, 54, 56, 58 includes a housing, case or enclosure having a plurality of cells. In some embodiments, the cells may include groups of series-connected cells, where the groups are then connected in parallel. The number of cells connected in series in each group provides a desired voltage level (e.g., 48 volts), while the number of the groups of these series-connected cells that are connected in parallel increases the available amp-hour capacity of the battery pack. In some embodiments, the cells may include groups of parallel-connected cells, where the groups are then connected in series. The number of groups of cells connected in series provides a desired voltage level (e.g., 48 volts), while the number of the parallel-connected cells in each group increases the available amp-hour capacity of the battery pack. In other embodiments, the battery pack 52, 54, 56, 58 may have a higher or lower voltage rating than 48 volts.

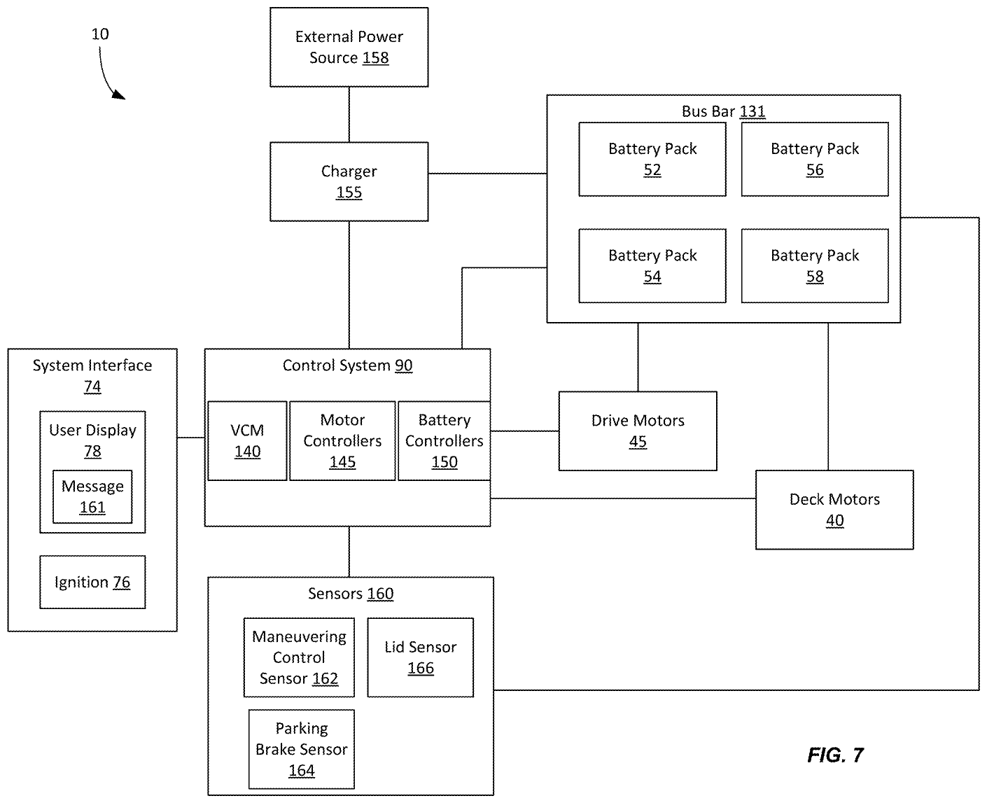

FIG. 7 illustrates a block diagram of the lawn mower 10, according to some embodiments. The mower 10 includes the vehicle control system 90 having at least one electronic controller such as a vehicle control module 140, motor controllers 145, and battery controllers 150. The control system 90 is in communication with the previously described deck motors 40, drive motors 45, system interface 74, a charger 155 that is configured to be selectively coupled to an external power source 158, the bus bar 131 that electrically connects the battery packs 52, 54, 56, 58 to the drive motors 45 and the deck motors 40, and sensors 160. In some embodiments, the control system 90 includes at least an electronic processor and a memory storing instructions executed by the electronic processor to implement the functionality of the control system. For example, the electronic processor and memory of the control system 90 may be formed as part of the vehicle control module 140, motor controllers 145, or the battery controllers 150. In other embodiments, the control system 90 includes a distributed processing system with a plurality of electronic processors and memories to implement the functionality, for example, distributed among the vehicle control module 140, motor controllers 145, or the battery controllers 150. The control system 90 and the battery packs 52, 54, 56, 58 may be in communication with the system interface 74 to display information regarding the operational state of mower 10. For example, the display 78 may receive a communication from the control system 90 and, in response, display a message 161 indicative of information provided in the communication. It should be appreciated that while the battery controllers 150 are illustrated in the control system 90, that the battery controllers 150 may include an individual battery controller integrally formed in each respective battery pack 52, 54, 56, 58.

With continued reference to FIG. 7, the sensors 160 include a maneuvering control sensor 162, a parking brake sensor 164, and a lid sensor 166. In some embodiments, additional sensors are also provided. The maneuvering control sensor 162 includes one or more sensors that are configured to sense and provide to the control system 90 an indication of a position of the maneuvering controls 72. For example, the maneuvering control sensor 162 may include a rotary encoder, a Hall sensor, a potentiometer, or the like, positioned near the pivot joint 73a, 73b of each maneuvering control arm 72a, 72b to indicate an angle of each respective maneuvering control arm 72a, 72b to the control system 90.

The parking brake sensor 164 is configured to indicate to the control system 90 whether the parking brake is activated. For example, the parking brake sensor 164 may be a push-button style switch that is actuated when the parking brake is activated, and that is de-actuated when the parking brake is deactivated.

The lid sensor 166 is operably coupled to the lid 104 and is configured to indicate to the control system 90 that the lid 104 is secured (e.g., via the latch 106) in the closed condition (e.g., as in FIGS. 1 and 2). The lid sensor 166 may be a push-button style switch that is actuated when a force is above a threshold amount, which indicates that the latch 106 is secured (e.g., providing a signal to the control system 90) and that is de-actuated when the force is less than the threshold amount (e.g., providing no signal to the control system 90). In some embodiments, other sensor types are used to implement one or more of the maneuvering control sensor 162, the parking brake sensor 164, and the lid sensor 166.

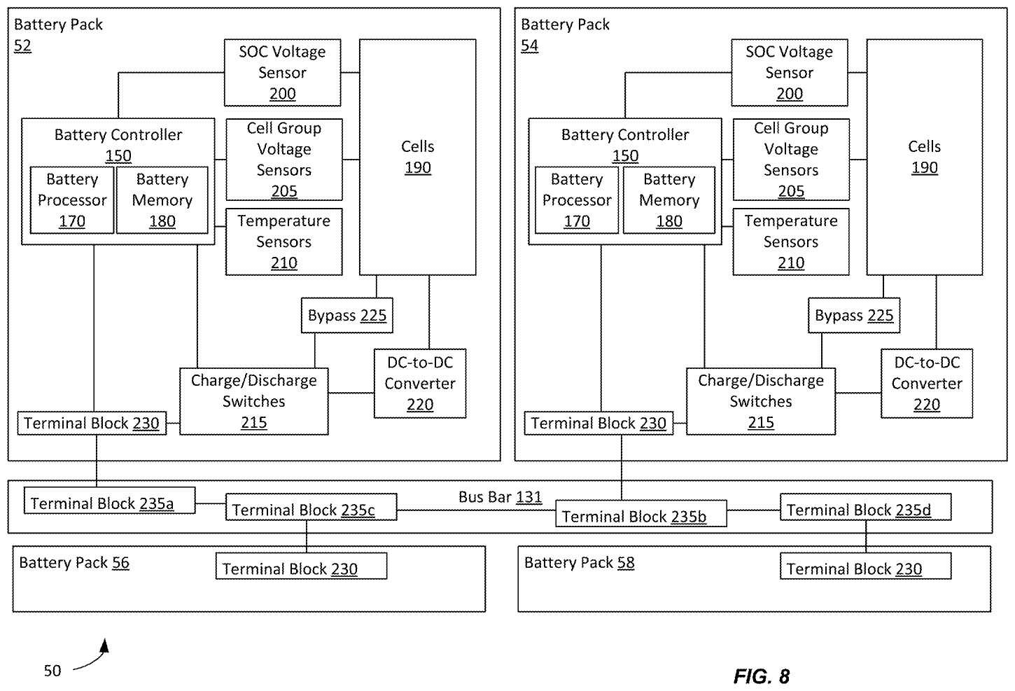

FIG. 8 illustrates the bank of battery packs 50 and the bus bar 131 in further detail. Although FIG. 8 is described primarily with respect to the battery pack 52, the illustration and description of the battery pack 52 similarly applies to the battery packs 54, 56 and 58. The battery pack 52 includes one of the battery controllers 150 including a battery electronic processor 170 and battery memory 180. The battery pack 52 further includes battery cells 190, a state-of-charge (SOC) voltage sensor 200, cell group voltage sensors 205, temperature sensors 210, charge-discharge switches 215, a DC-to-DC converter 220 positioned between the battery cells 190 and the charge-discharge switches 215, a bypass 225 positioned between the battery cells 190 and the charge-discharge switches 215, and a terminal block 230. The bypass 225 is, for example, a power switching element (e.g., a field effect transistor) that is selectively actuated by a signal from the battery controller 150. When actuated, the bypass 225 provides a direct path from the cells 190 to the charge/discharge switches 215, bypassing the converter 220. When disabled, the bypass 225 interrupts the direct path from the cells 190 to the charge/discharge switches 215. When the direct path is interrupted by the bypass 225 being disabled, the DC-to-DC converter (when activated) provides a path from the charge/discharge switches 215 to the cells 190.

The battery memory 180 stores instructions that, when executed by the battery electronic processor 170, implement the functionality of the battery controller 150 described herein. The SOC voltage sensor 200 is configured to measure the voltage across the cells 190 (e.g., at a positive and negative terminal point for the entire set of the cells 190) and to provide the voltage measurement to the battery controller 150, which is indicative of the state of charge of the cells 190 (and, thus, of the battery pack 52). The cell group voltage sensors 205 include a plurality of voltage sensors that each are configured to measure the voltage across a cell group of the plurality of cells. For example, the cell group voltage sensors 205 may measure the voltage across a group of parallelly-connected cells or across a group of series-connected cells.

The temperature sensors 210 include one or more temperature sensors arranged about the cells 190 to provide internal temperature measurements of the battery pack 52 to the battery controller 150. The terminal block 230 includes the electrical connectors for the battery pack 52 and is electrically connected to a first terminal block 235a of the bus bar 131 (e.g., the electrical connectors 126 of a docking station 122).

As noted, the description of the battery pack 52 and its elements shown in FIG. 8 similarly applies to the battery pack 54, 56, and 58. The battery packs 56 and 58 include similar components as shown to in the battery packs 52 and 54 in FIG. 8 (e.g., the battery controller 150, SOC voltage sensor 200, bypass 225, etc.), but the components are not illustrated in FIG. 8 to simplify the diagram.

The battery packs 54, 56, 58 are also electronically connected to respective terminal blocks 235b, 235c, 235d so that the battery packs 52, 54, 56, 58 are coupled in parallel by the bus bar 131. The battery controller 150 of each battery pack 52, 54, 56, 58 may communicate with the battery controller 150 of each other battery pack 52, 54, 56, 58 (e.g., via CAN communication), with the user display 78, and with other controllers of the mower 10, such as the vehicle control module 140 and motor controllers 145 (see FIG. 7). For example, the battery controllers 150 may communicate the state of charge of each battery 52, 54, 56, 58 (i.e., the voltage of each battery pack) to each other and the user display 78 via CAN communication over, at least in part, the bus bar 131.

The control system 90 (as a specific example, one of the battery controllers 150) may initiate a battery balancing method 300 (described in more detail below) based on the state of charge of each battery pack 52, 54, 56, 58. For various reasons, the battery packs 52, 54, 56, 58 may have different states of charge (e.g., fully (100%) charged, 75% charged, 25% charged, etc.). When the difference between the states of charge of connected battery packs 52, 54, 56, 58 is more than a threshold amount (e.g., 12%), the packs are considered out-of-balance or imbalanced. When one or more of the battery packs 52, 54, 56, 58 is out-of-balance with another of the battery packs 52, 54, 56, 58, the simultaneous discharge from one or more of the battery packs 52, 54, 56, 58 may be prevented to avoid damage that could otherwise result, for example, from reverse current to the battery pack(s) having a lower state of charge. For example, in some embodiments, during operation of the lawn mower 10, the state of charge of a lowest charged battery pack has to be less than an operational threshold amount below a highest charged battery pack for all of the battery packs 52, 54, 56, 58 to provide power simultaneously to the mower 10. For example, the operational threshold amount may be 12 percent of the state of charge. In some embodiments, the operational threshold amount may be greater than or less than 12 percent of the state of charge.

Battery balancing allows the battery packs 52, 54, 56, 58 to transfer charge from one or more packs with a higher state of charge to one or more packs having a lower state of charge to bring the states of charge of the one or more battery packs 52, 54, 56, 58 nearer to one another. By balancing imbalanced battery packs 52, 54, 56, 58, two or more battery packs 52, 54, 56, 58 may be permitted to simultaneously discharge to power the mower 10, which can increase available current to the mower 10 and extend the runtime of the mower 10 before re-charging or swapping one or more battery packs 52, 54, 56, 58.

In some embodiments, when the state of charge of the lowest charged battery pack is greater than the operational threshold amount below the highest charged battery pack, the mower 10 may only receive power from the highest charged battery pack or a subgroup of battery packs. For example, the subgroup of battery packs may include the highest charged battery pack and the other battery packs that have a state of charge that is less than the operational threshold amount below the highest charged battery pack. In the illustrated embodiment, at least two battery packs 52, 54, 56, 58 must be within the operational threshold amount for the lawn mower 10 to operate both the drive motors 45 and the deck motors 40. In other words, a single battery pack 52 does not have enough power or is not permitted to operate both the deck motors 40 and the drive motors 45. As such, when the control system 90 determines that none of the battery packs 54, 56, 58 are within the operational threshold amount of the first battery pack 52, the control system 90 may disable the deck motors 40 (but allow operation of the drive motors 45).

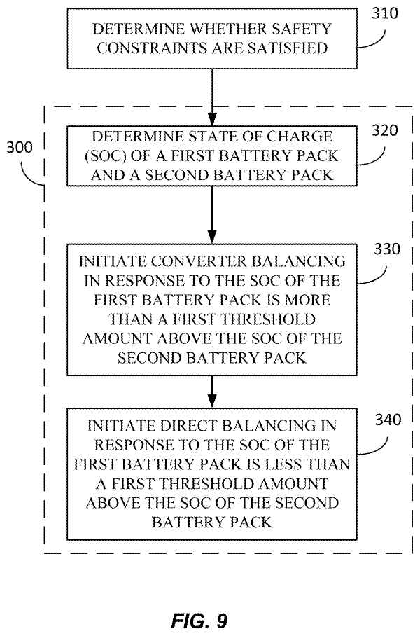

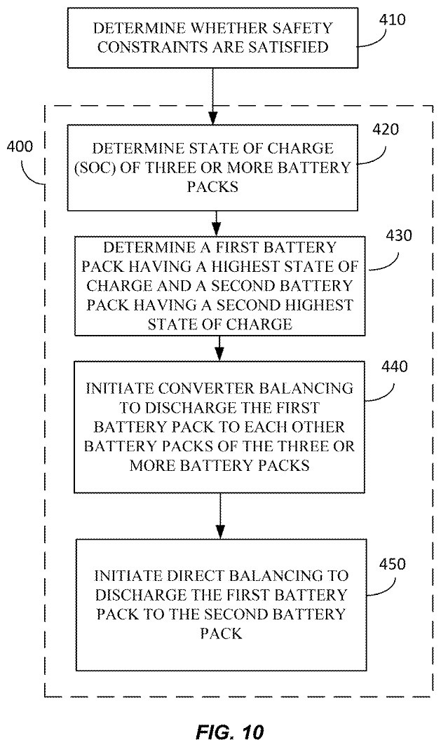

The control system 90 is operable to automatically initiate the balancing method 300 (FIG. 9), 400 (FIG. 10) so that voltage is discharged from one of the higher-charged battery packs (e.g., pack 52) to one or more of the lower-charged battery packs (e.g., packs 54, 56, 58) until the battery packs 52, 54, 56, 58 are within the predetermined operational threshold. In some embodiments, during battery balancing, the terminal block 230 of one battery pack (e.g., pack 52) that has highest state of charge, is connected to the terminal block 230 of the one or more of the other battery packs (e.g., packs 54, 56, 58) having a lower state of charge to charge or transfer voltage to one or more of the other battery packs. As explained in further detail below, the control system 90 is able to selectively change between direct balancing (e.g., fast balance) and converter balancing (e.g., slow balance) based on the state of charge of the battery packs 52, 54, 56, 58.

FIG. 9 illustrates an example battery balancing method according to some embodiments. Although the method 300 is described with respect to the utility vehicle 10 as shown herein, the method 300 may also be implemented on another utility vehicle (e.g., having more or fewer drive motors, more or fewer deck motors, and more or fewer battery packs) or on other utility vehicles. The method 300 is described in view of a power source having two battery packs, the (first) battery pack 52 and the (second) battery pack 54. However, it should be appreciated that the method 300 may be applied to any combination of two of the battery packs 52, 54, 56, 58 and to utility vehicles with more than two battery packs.

In block 310, the control system 90 (e.g., one or more of the battery controllers 150) determines whether safety constraints for the utility vehicle 10 are satisfied as a precondition to initiating the battery balancing method 300. In response to the control system 90 determining that the safety constraints are satisfied, the control system 90 proceeds to block 320. The safety constraints for the utility vehicle 10 may include one or more of: determining whether the ignition 76 is off (e.g., the mower 10 is powered off), the parking brake is engaged, and the lid 104 is in the closed position (FIGS. 1-3). For example, the parking brake sensor 164 may provide a communication to the control system 90 indicative of whether the parking brake is engaged and the lid sensor 166 may provide a communication to the control system 90 indicative of whether the lid 104 is secured. In some embodiments, block 310 is bypassed and the control system 90 does not perform a safety constraint check. In other embodiments, different combinations of safety constraints or additional safety constraints may be implemented.

In block 320, the control system 90 determines the state of charge of the first battery pack 52 and the second battery pack 54. In the illustrated embodiment, the battery controllers 150 of the battery packs 52, 54 determine the state of charge of the battery packs 52, 54, respectively, and communicate the determined states of charge with one another. For example, the state of charge voltage sensor 200 of the battery pack 52 may determine the state of charge of the cells 190 of the pack 52 and communicate a message indicative of the determined state of charge of the pack 52 to the battery controller 150 of the pack 52. The battery controller 150 of the battery pack 54 may similarly determine the state of charge of the cells 190 of the pack 54 using the state of charge voltage sensor 200 of the pack 54. The controller 150 of the battery pack 52 may communicate the determined state of charge of the pack 52 to the controller 150 of the battery pack 54; the controller 150 of the battery pack 54 may communicate the determined state of charge of the pack 54 to the controller 150 of the battery pack 52, or each controller 150 may communicate to the other controller 150 the determined state of charge of the respective packs 52, 54. For example, each controller 150 may broadcast the determined state of charge of its associated battery pack on the bus bar 131 (e.g., on a CAN bus of the bus bar 131) along with an identifier for the associated battery pack.

In block 330, the control system 90 initiates converter battery balancing to discharge the first battery pack 52 to the second battery pack 54 through the DC-to-DC converter 220 in response to the first battery pack 52 having a state of charge that is more than a first threshold amount above a state of charge of the second battery pack 54. For example, using the states of charge of the battery packs 52, 54 previously determined in block 320, the control system 90 calculates a difference between the states of charge of the battery packs 52 and 54, and then compares that calculated difference with the first threshold. When the calculated difference is more than the first threshold, the control system initiates converter battery balancing. In some embodiments, the first threshold amount may be 30 percent of the state of charge of the battery packs 52, 54. As such, if the first battery pack 52 has a state of charge of 70 percent and the second battery pack 54 has a state of charge of 30 percent, the battery controller 150 initiates converter balancing since the state of charge of the first battery pack 52 is more than 30 percent above the state of charge of the second battery pack 54. In other embodiments, the first predetermined threshold amount may be less than or greater than 30 percent.

In the illustrated embodiment, to initiate converter battery balancing, the control system 90 (e.g., the battery controller 150 of the battery pack 54) activates the DC-to-DC converter 220 of the battery pack 54. For example, the control system 90 sends an enable command to the DC-to-DC converter 220 of the battery pack 54 to begin converting voltage from the battery pack 52 received via the bus bar 131. In some embodiments, to initiate converter battery balancing, the control system 90 also (i) disables the bypass 225 of the battery pack 54, (ii) enables at least one charge switch of the charge/discharge switches 215, (iii) enables a discharge switch of the charge/discharge switches 215 of the battery pack 52, and (iv) enables the bypass 225 of the battery pack 52.

The activated DC-to-DC converter 220 reduces or steps down the amount of voltage from the battery pack 52 to charge the battery pack 54. The use of the DC-to-DC converter 220 reduces the potential (voltage) difference between the charging source and the cells 190 of the to-be-charged battery pack 54. By reducing the potential difference, the DC-to-DC converter 220 reduces the charge current from the battery pack 52 to the battery pack 54 during the balancing. Without such reduction, the high potential difference between he battery pack 52 (charge source) and the battery pack 54 (to-be-charged battery) can result in excessive current, which can damage components of one or both of the battery pack 52 and 54. In other embodiments, the DC-to-DC converter 220 that is activated may be alternatively positioned between the first and second battery packs 52, 54 (e.g., on the bus bar 131, in the battery pack 52, etc.).

In block 340, the control system 90 (e.g., via the battery controller 150) initiates direct battery balancing to discharge the first battery pack 52 to the second battery pack 54 in response to the first battery pack 52 having a state of charge that is less than the first threshold amount above a state of charge of the second battery pack 54. For example, using the states of charge of the battery packs 52, 54 previously determined in block 320, the control system 90 calculates a difference between the states of charge of the battery packs 52 and 54, and then compares that calculated difference with the first threshold. When the calculated difference is less than the first threshold, the control system initiates direct battery balancing. For example, using the example first threshold of 30 percent, if the first battery pack 52 has a state of charge of 64 percent and the second battery pack 54 has a state of charge of 36 percent, the battery controller 150 initiates direct balancing because the state of charge of the first battery pack 52 is less than 30 percent above the state of charge of the second battery pack 54.

To initiate direct balancing, the control system 90 enables the bypass 225 of the battery pack 54 to connect the cells 190 to the battery pack 52 via the bus bar 131. In some embodiments, to initiate direct balancing, the control system 90 further (i) enables a charge switch of the charge/discharge switches 215 of the battery pack 52, (ii) disables the DC-to-DC converter 220 of the battery pack 54, (iii) enables a discharge switch of the charge/discharge switches 215 of the battery pack 52, and (iv) enables the bypass 225 of the battery pack 52. Accordingly, in direct balancing, current discharged from the battery pack 52 is directly provided to the battery pack 54 without a DC-to-DC conversion from one of the DC-to-DC converters 220 (any losses from the charge/discharge switches 215, resistance of the bus bar 131, and the like are considered negligible). Direct balancing is more efficient, avoiding the losses of the DC-to-DC conversion, and results in higher average charging current and faster balancing than converter balancing.

Direct balancing of the battery packs 52 and 54 may continue, for example, until the battery packs 52 and 54 are equal or nearly equal, until one of the battery packs 52 or 54 is removed from the battery compartment, or until an operator turns on the mower 10 (e.g., activates the ignition 76) and the battery packs 52 and 54 begin powering components of the mower 10 (e.g., one or both of the deck motors 40 and drive motors 45).

In some embodiments, the control system 90 may repeatedly loop through the method 300 to determine updated values for the states of charge of the battery packs 52 and 54 and to initiate either converter balancing or direct balancing depending on the difference between the states of charge of the battery packs 52 and 54. Accordingly, the control system 90 may automatically change from converter balancing to direct balancing once the converter balancing initiated in the block 330 brings the state of charge of the first battery pack 52 to less than first threshold (e.g., 30 percent) above the state of charge of the second battery pack 54.

In some embodiments, when the method 300 starts with battery packs 52 and 54 having states of charge within the first threshold (e.g., within 30 percent of each other), the control system 90 may bypass block 330 (converter balancing) and proceed to block 340 to initiate direct battery balancing.

In some embodiments, one of the battery controllers 150 (e.g., the battery controller 150 of the battery pack 52) is selected as the master battery controller, and the master battery controller implements the functions of the control system 90 described with respect to the method 300. For example, the master battery controller determines the state of charge of the first and second battery packs 52, 54 (block 320), initiates converter balancing in response to the state of charge of the first battery being more than a first threshold amount above the state of charge of the second battery pack (block 330), and initiates direct balancing in response to the state of charge of the first battery pack being less than the first threshold amount above the state of charge of the second battery pack (block 340). In some embodiments, one of the battery controllers 150 of the battery packs 52, 54 is identified as a master battery controller based on, for example, the order of connection to the bus bar 131, lowest identifier number, highest state of charge, or another technique. To implement the determinations and initiate the balancing, the master battery controller may communicate with the battery controller 150 of the other battery pack(s) over the bus bar 131. The communications may include, for example, receiving information and sending commands.

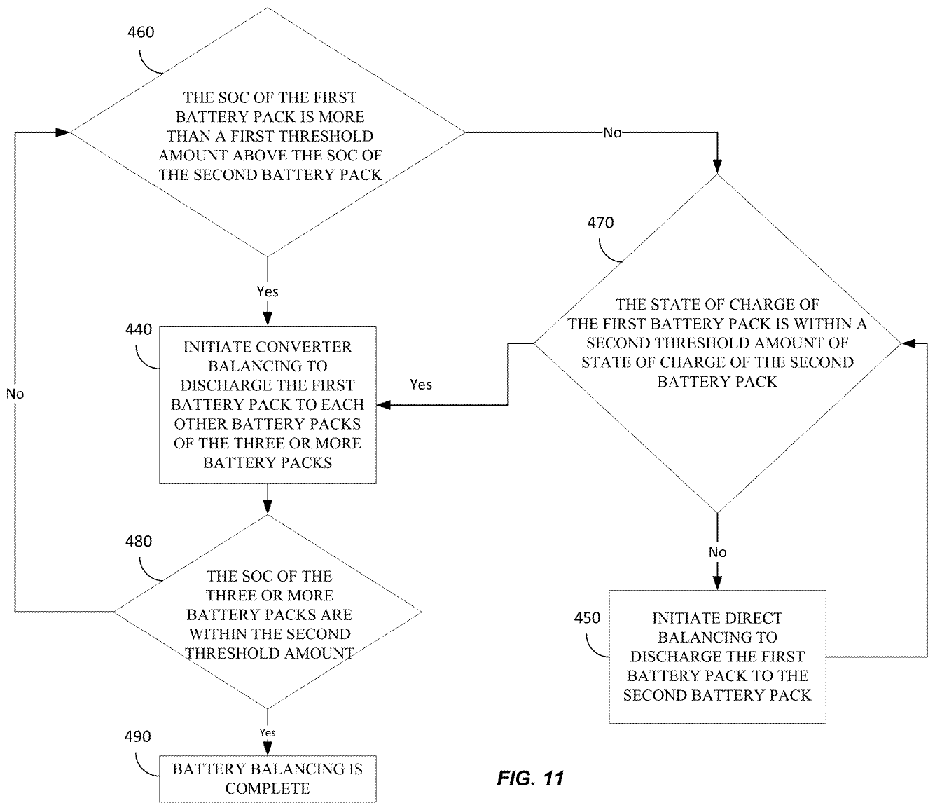

FIGS. 10 and 11 illustrate an example battery balancing method 400 according to some embodiments. Although the method 400 is described with respect to the utility vehicle 10 as shown herein, the method 400 may also be implemented on another utility vehicle (e.g., having more or fewer drive motors, more or fewer deck motors) or on other utility vehicles. The method 400 is described in view of a power source having three battery packs for the sake of clarity. However, it should be appreciated that the method 400 may be applied to utility vehicles with more than three battery packs.

In block 410, the control system 90 (e.g., one or more battery controller 150) determines whether safety constraints for the utility vehicle 10 are satisfied as a precondition to initiating the battery balancing method 400. It should be appreciated that the safety constraints and the determination of whether the safety constraints are satisfied may be similar to the constraints and determination described above with reference to block 310. Additionally, in some embodiments, block 410 is bypassed and the control system 90 does not perform a safety constraint check.

In block 420, the control system 90 determines the state of charge of three or more battery packs 52, 54, 56, 58. The control system 90 may determine the state of charge of the three or more battery packs 52, 54, 56, 58 using similar techniques as described above with respect to block 310 of FIG. 9. For example, for each pack, the state of charge voltage sensor 200 may provide an indication of the state of charge of the cells 190 to the associated battery controller 150 of the pack, and then the battery controller 150 of each pack may communicate a message indicative of the determined state of charge to the battery controller 150 of each other battery pack (e.g., over the bus bar 131).

In block 430, the control system 90 determines a first battery pack 52 having a highest state of charge and a second battery pack 54 having a second highest state of charge. The control system 90 may further determine a third highest state of charge, a fourth highest state of charge, etc. For example, the control system 90 may perform one or more comparisons of the determined states of charge of the battery packs 52, 54, 56, 58 to determine which of the battery packs has the highest state of charge, the second highest state of charge, etc.

In block 440, the control system 90 initiates converter balancing to discharge the first battery pack (i.e., the battery pack with the highest state of charge) to each of the other battery packs of the three or more battery packs 54, 56, 58. The flow chart of FIG. 11 provides further explanation but, briefly, in some embodiments, the converter balancing may be initiated based on either of two conditions. First, this converter balancing may be initiated based on the first battery pack having a state of charge that is more than a first threshold amount above a state of charge of the second battery pack (i.e., the battery pack having the second highest state of charge). Second, this converter balancing may also be initiated based on the first battery pack having a state of charge that is within a second threshold amount of a state of charge of the second battery pack, which is indicative of the first and second battery having the same or nearly the same state of charge. In other words, in some embodiments, the second threshold amount is a relatively a low value (e.g., 0.5 percent, 1 percent, or 3 percent) and is used to determine when the first and second battery have essentially an equal state of charge (i.e., within a margin of error set by the second threshold).

Regardless of the basis for initiating converter balancing, the control system 90 may initiate converter balancing using similar techniques as described above with respect to block 330. For example, to initiate converter battery balancing, the control system 90 activates the DC-to-DC converter 220 of the battery pack(s) 52, 54, 56, 58 to be charged. In some embodiments, to initiate converter battery balancing, the control system 90 also (i) disables the bypass 225 of each of the battery packs 52, 54, 56, 58 to be charged, (ii) enables at least one charge switch of the charge/discharge switches 215 for each of the battery packs 52, 54, 56, 58 to be charged, (iii) enables a discharge switch of the charge/discharge switches 215 of each of the battery packs 52, 54, 56, 58 that will be providing charge current, and (iv) enables the bypass 225 of each of the battery packs 52, 54, 56, 58 that will be providing charge current. The battery packs 52, 54, 56, 58 that provide charging current in the converter balancing of the method 400 include the first battery pack having the highest state of charge or, if more than one of the battery packs 52, 54, 56, 58 has the same highest state of charge, those additional battery packs. Thus, for example, if the battery packs 52, 54, 56, 58 have states of charge of 80 percent, 80 percent, 50 percent, and 40 percent, respectively, the two battery packs 52 and 54 having 80 percent state of charge will provide charging current during the converter balancing, and the two battery packs 56 and 58 will receive the charging current during the converter balancing.

In block 450, the control system 90 initiates direct balancing to discharge the first battery pack 52 to the second battery pack 54. The flow chart of FIG. 11 provides further explanation but, briefly, in some embodiments, the direct balancing may be initiated based on the first battery pack (i.e., with the highest state of charge) having a state of charge that is between the first threshold amount and the second threshold amount above the state of charge of the second battery pack.

Now with reference to FIG. 11, the control logic of the control system 90 (e.g., the battery controllers 150) to initiate blocks 440 and 450 is illustrated. For purposes of illustration with respect to FIG. 11, we presume that the battery pack 52 has been determined to have the highest state of charge, and that the battery pack 54 has been determined to have the second highest state of charge (e.g., in block 430 of FIG. 9). In block 460, the control system 90 determines whether the state of charge of the first battery pack 52 is more than a first threshold amount above the state of charge of the second battery pack 54. For example, the first threshold amount may be 30 percent of the maximum state of charge of the battery packs 52, 54, 56, 58. When the state of charge of the first battery pack 52 is more than the first threshold amount above the state of charge of the second battery pack 54, the control system 90 initiates converter balancing to discharge the first battery pack (e.g., a highest state of charge battery pack) to each of the other battery packs of the three or more battery packs 54, 56, 58 (block 440). In other words, the control system 90 initiates converter balancing to charge each of the remaining battery packs 54, 56, 58 coupled to the bus bar 131 until the state of charge of the first battery pack 52 is not more than (i.e., is less than or equal to) the first threshold amount above the state of charge of the second battery pack 54.

When the state of charge of the first battery pack 52 is not more than the first threshold amount above the state of charge of the second battery pack 54, the control system 90 determines whether the state of charge of the first battery pack 52 is within a second threshold amount of the state of charge of the second battery pack 54 (block 470). The second threshold is selected such that, when the state of charge of the first battery pack 52 is within the second threshold amount of the state of charge of the second battery pack 54, it is indicative of the first and second battery pack having the same or nearly the same state of charge. In other words, in some embodiments, the second threshold amount is a relatively a low value (e.g., 0 percent, 0.5 percent, 1 percent, or 3 percent) and is used to determine when the first and second battery have essentially an equal state of charge (i.e., within a margin of error set by the second threshold). When the state of charge of the first battery pack 52 is not within the second threshold amount of the state of charge of the second battery pack 54, the control system 90 initiates direct balancing to discharge the first battery pack 52 to the second battery pack 54 (block 450). The control system 90 may initiate direct balancing between the first and second battery packs 52, 54 and loop between blocks 450 and 470 until the state of charge of the first battery pack 52 is within the second threshold amount (e.g., is equal to) the state of charge of the second battery pack 54.

Once the direct balancing is finished between the first and second battery packs 52, 54 (i.e., the state of charge of the first battery pack 52 is within the second threshold amount (e.g., is equal or substantially equal to) the state of charge of the second battery pack 54), the control system 90 may initiate converter balancing (block 440) to discharge the first and second battery packs 52, 54 to each other of the three or more battery packs 56, 58.

In block 480, the control system 90 determines whether the state of charge of each of the three or more battery packs 52, 54, 56, 58 are within the second threshold amount. It should be appreciated that since the state of charge of the first and second battery packs 52, 54 are within the second threshold amount, that the control system 90 may initiate converter balancing to discharge from one or both of the first or second battery pack 52, 54 to charge the remaining battery packs 56, 58 that have a state of charge that are not within the second threshold amount. For example, the control system 90 may discharge equally from both of the first and second battery packs 52, 54 so the state of charge of the first and second battery packs remain within the second threshold amount. When the state of charge of each of the three or more battery packs 52, 54, 56, 58 are within the second threshold amount, the control system 90 determines that battery balancing is complete (block 490). In other words, the control system 90 may initiate converter balancing until all of the battery packs 52, 54, 56, 58 have an equal state of charge.

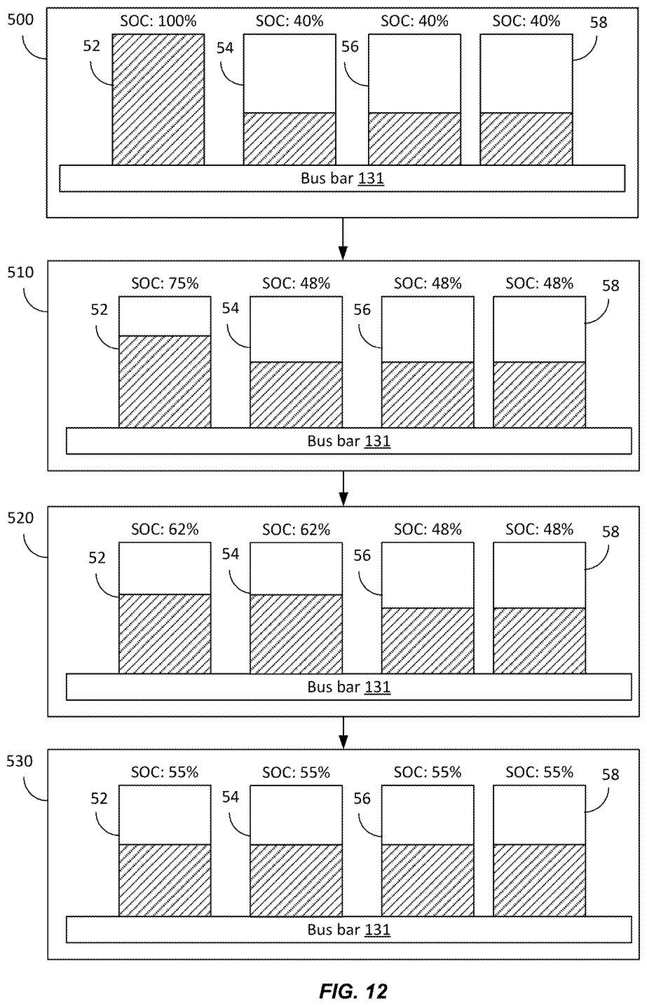

An example implementation of the balancing method 400 with four battery packs 52, 54, 56, 58 coupled to the bus bar 131 is illustrated in FIG. 12. For example, in block 500, the first battery pack 52 has a state of charge of 100 percent and the second, third, and fourth battery packs 54, 56, 58 have a state of charge of 40 percent. The control system 90 determines that the state of charge of the first battery pack 52 (e.g., 100 percent) is more than the first threshold amount (30 percent) above the state of charge of the second battery pack 54 (block 460). As such, the control system 90 initiates converter charging (block 440) to charge each of the remaining battery packs 54, 56, 58 coupled to the bus bar 131 until the state of charge of the first battery pack 52 is not more than (e.g., is less than) the first threshold amount above the second battery pack 54. For example, in block 510, the converter balancing discharges the first battery pack 52 to a state of charge of 75 percent and charges the remaining battery packs 54, 56, 58 to a state of charge of 48 percent.

The control system 90, determines that the state of charge of the first battery pack 52 is not more than (e.g., is less than) the first threshold amount above the state of charge of the second battery pack 54 (block 460) and that the first battery pack 52 is not within the second threshold amount of the state of charge of the second battery pack 54 (block 470). As such, the control system 90 initiates direct balancing to discharge the first battery pack 52 to the second battery pack 54 until the first and second battery packs are within the second threshold amount (block 450) (e.g., until the battery packs 52, 54 have equal states of charge). For example, in block 520, the direct balancing discharges the first battery pack 52 to a state of charge of 62 percent and charges the second battery pack 54 to a state of charge of 62 percent, while the third and fourth battery packs remain at a state of charge of 48 percent. In block 520, the utility vehicle 10 may be operated using two battery packs 52, 54.

In block 520, the control system 90 determines that the state of charge of the second battery pack 52 is within the state of charge of the first battery pack 52 (block 470). The control system 90 continues to balance the battery packs 52, 54, 56, 58 by initiating converter balancing (block 440). The control system 90 further determines whether the battery packs 52, 54, 56, 58 are within the second threshold amount (block 480) (e.g., the battery packs 52, 54, 56, 58 equal state of charges) and determines the battery balancing is complete (block 490) once the state of charge of the battery packs 52, 54, 56, 58 are within the second threshold amount (e.g., each battery pack has a state of charge of 55 percent).

In some embodiments, as described with respect to the method 300 of FIG. 9, one of the battery controllers 150 (e.g., the battery controller 150 of the battery pack 52) is selected as the master battery controller, and the master battery controller implements the functions of the control system 90 described with respect to the method 400. For example, the master battery controller determines the state of charge of the battery packs 52, 54, 56, 58 (block 420), determines the first and second battery packs having the highest and second highest states of charge (block 430), initiates converter balancing to discharge the first battery pack to each other battery pack (block 440), initiates direct balancing to discharge the first battery pack to the second battery pack (block 450), and performs the determinations in blocks 460, 470, and 480 in FIG. 11. In some embodiments, one of the battery controllers 150 of the battery packs 52, 54 is identified as a master battery controller based on, for example, the order of connection to the bus bar 131, lowest identifier number, highest state of charge, or another technique. To implement the determinations and initiate the balancing, the master battery controller may communicate with the battery controller 150 of the other battery pack(s) over the bus bar 131. The communications may include, for example, receiving information and sending commands.

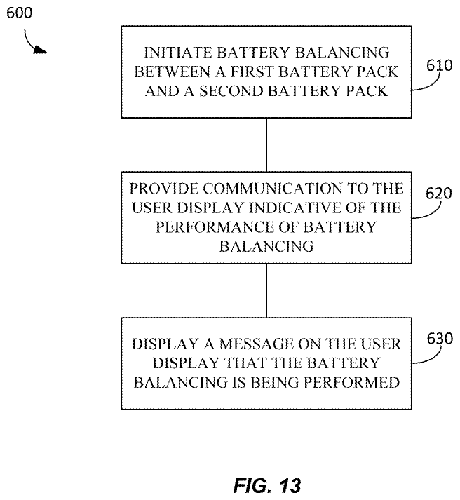

FIG. 13 illustrates a battery balancing and notification method 600 for the utility vehicle. In block 610, the control system 90 initiates battery balancing between a first battery pack and a second battery pack (e.g., between the battery pack 52 and battery pack 54) on the utility vehicle 10 that are coupled by a bus bar 131. Initiating battery balancing in block 610 may stem from, for example, the control system 90 executing one of the battery balancing methods 300, 400. Accordingly, the initiated battery balancing in block 610 may include one or more of converter balancing as described with respect to blocks 330 (FIG. 9) and 440 (FIG. 10) and direct balancing as described with respect to blocks 340 (FIG. 9) and 450 (FIG. 10).

In block 620, the control system 90 provides a communication to the user display 78 of the utility vehicle 10 that is indicative of the performance of battery balancing. For example, the control system 90 may provide a message to the user display 78 indicating that the battery balancing has been initiated. The control system 90 may further provide a communication to the user display 78 indicating the state of charge of the battery packs 52, 54, 56, 58, and other characteristics of the battery balancing. The characteristics of the battery balancing may include an amount of time remaining in the battery balancing and the type of battery balancing (e.g., converter balancing or direct balancing). In some embodiments, such as where the control system 90 is implemented by one the battery controllers 150 residing on respective battery packs 52, 54, 56, 58, the communication may be provided by the battery controller 150 via the bus bar 131. The bus bar 131 may include a portion of a communication bus (e.g., a CAN bus) to which the user display 78 is also coupled. Accordingly, the communication may be a CAN message that the user display 78 receives. Although the communication in block 620 is referred to in the singular, the communication in block 620 may include a single communication message or may include a plurality of communication messages sent over a period of time (e.g., one communication message indicating battery balancing has begun, one communication message indicating a type of battery balancing, one communication message indicating the state of charge of the battery packs, and the like).

In block 630, a message is displayed on the user display 78 of the utility vehicle 10 indicating that battery balancing is being performed. The message, for example, the message 161 shown in FIG. 7, is displayed by the user display 78 in response to receipt of the communication from the control system 90 and indicates information received in the communication. For example, the message 161 may include text, graphics, or icons on the user display 78 that indicate battery balancing is in operation. In some embodiments, the message 161 may further include the state of charge of one or more of the battery packs 52, 54, 56, 58 (e.g., indicated as a percentage or bar graph, such as shown in FIG. 12), and characteristics of the battery balancing such as the amount of time until the utility vehicle 10 is operable (e.g., until two battery packs are balanced), the amount of time until all the battery packs are fully balanced, and the type of battery balancing being performed.

In some embodiments, during the course of battery balancing, the method 600 loops between blocks 620 and 630 such that the control system 90 provides further communications with updated information (e.g., battery balancing operation state, battery balancing type, state of charge of battery packs, or characteristics of the battery balancing) and the user display 78 updates the message 161 with the updated information.

Thus, embodiments described herein provide, among other things, systems, methods, and devices related to balancing battery packs of electric vehicles. Various features, advantages, and embodiments are set forth in the following claims.

1. A battery balancing method for balancing voltages of battery packs on a bus bar of a utility vehicle, the battery balancing method comprising:
determining, by a control system including at least one electronic controller, a state of charge for a first battery pack and a state of charge for a second battery pack of the utility vehicle;
initiating converter battery balancing, by the control system, to discharge the first battery pack to the second battery pack through a DC-to-DC converter in response to determining that the state of charge of the first battery pack is more than a first threshold amount above the state of charge of the second battery pack; and
initiating direct battery balancing, by the control system, to discharge the first battery pack to the second battery pack in response to determining that the state of charge of the first battery pack is less than the first threshold amount above the state of charge of the second battery pack.

2. The battery balancing method of claim 1, wherein:
initiating the direct battery balancing includes enabling, with the control system, a bypass positioned between the first and second battery packs to connect the first and second battery packs, and disabling the DC-to-DC converter, and
initiating the converter battery balancing includes disabling the bypass.

3. The battery balancing method of claim 1, further comprising determining whether safety constraints of the utility vehicle are satisfied as a precondition to initiating the converter battery balancing or the direct battery balancing.

4. The battery balancing method of claim 1, further comprising:
determining, by the control system, a state of charge of a third battery pack of the utility vehicle; and
initiating converter battery balancing, by the control system, to discharge the first battery pack to each of the second and third battery packs through the DC-to-DC converter in response to determining that the state of charge of the first battery pack is within a second threshold amount of the state of charge of the second battery pack.

5. The battery balancing method of claim 1, further comprising:
providing, by the control system to a user display of the utility vehicle, a communication that is indicative of the performance of battery balancing; and
displaying, in response to the communication, a message on the user display of the utility vehicle that the battery balancing is being performed.

6. The battery balancing method of claim 5, further comprising:
displaying, in response to a second communication provided by the control system, the state of charge of the first and second battery packs on the user display of the utility vehicle.

7. The battery balancing method of claim 5, further comprising:
determining, by the control system, characteristics indicative of the battery balancing; and
displaying, in response to the communication, a message including the characteristics of the battery balancing.

8. The battery balancing method of claim 7, wherein the characteristics indicative of the battery balancing includes at least one selected from the group of:
an amount of time remaining in the battery balancing; and
a type of battery balancing that is being performed.

9. (canceled)

10. (canceled)

11. (canceled)

12. (canceled)

13. (canceled)

14. A battery balancing method for balancing voltages of battery packs on a bus bar of a utility vehicle, the battery balancing method comprising:
determining, by a control system including at least one electronic controller, a state of charge for each battery pack of three or more battery packs of the utility vehicle;
determining, by the control system, a first battery pack having a highest state of charge of the three or more battery packs and a second battery pack having a second highest state of charge of the three or more battery packs;
initiating converter battery balancing, by the control system, to discharge the first battery pack to each other battery pack of the three or more battery packs through a DC-to-DC converter in response to at least one selected from the group of:
determining that the state of charge of the first battery pack is more than a first threshold amount above the state of charge of the second battery pack, and
determining that the state of charge of the first battery pack is within a second threshold amount of the state of charge of the second battery pack; and
initiating direct battery balancing, by the control system, to discharge the first battery pack to the second battery pack in response to determining that the state of charge of the first battery pack is between the first threshold amount and the second threshold amount above the state of charge of the second battery pack.

15. The battery balancing method of claim 14, wherein:
initiating the direct battery balancing includes enabling, with the control system, a bypass positioned between the first and second battery packs to connect the first and second battery packs, and disabling the DC-to-DC converter, and
initiating the converter battery balancing includes disabling the bypass.

16. The battery balancing method of claim 14, further comprising:
determining whether safety constraints of the utility vehicle are satisfied as a precondition to initiating the converter battery balancing or the direct battery balancing.

17. A utility vehicle comprising:
a frame;
a drive wheel supporting the frame above a ground surface;
a drive motor mounted to the frame and driving rotation of the drive wheel to move the utility vehicle over the ground surface;
an operator platform supported by the frame, and operable to support the weight of a user during operation of the utility vehicle;
a utility device coupled to the frame;
two or more battery packs electrically connected to a bus bar and supported by the frame; and
a control system including at least one electronic controller, the control system in communication with the drive motor, the utility device, and the two or more battery packs, the control system configured to:
determine a state of charge for a first battery pack and a state of charge for a second battery pack of the utility vehicle;
initiate converter battery balancing to discharge the first battery pack to the second battery pack through a DC-to-DC converter in response to determining that the state of charge of the first battery pack is more than a first threshold amount above the state of charge of the second battery pack; and
initiate direct battery balancing to discharge the first battery pack to the second battery pack in response to determining that the state of charge of the first battery pack is less than the first threshold amount above the state of charge of the second battery pack.

18. The utility vehicle of claim 17, wherein the control system is further configured to:
initiate the direct battery balancing by enabling a bypass positioned between the first and second battery packs to connect the first and second battery packs, and disabling the DC-to-DC converter; and
initiate the converter battery balancing by disabling the bypass.

19. The utility vehicle of claim 17, wherein the control system is further configured to determine whether safety constraints of the utility vehicle are satisfied as a precondition to initiating the converter battery balancing or the direct battery balancing.

20. The utility vehicle of claim 17, wherein the control system is further configured to:
determine a state of charge of a third battery pack of the utility vehicle; and
initiate converter battery balancing to discharge the first battery pack to each of the second and third battery packs through the DC-to-DC converter in response to determining that the state of charge of the first battery pack is within a second threshold amount of a state of charge of the second battery pack.

21. The utility vehicle of claim 17, wherein:
the utility vehicle is an electric lawn mower, and
the utility device is a cutting deck.

22. (canceled)

23. (canceled)

24. (canceled)

25. (canceled)

26. (canceled)

27. A utility vehicle comprising:
a frame;
a drive wheel supporting the frame above a ground surface;
a drive motor mounted to the frame and driving rotation of the drive wheel to move the utility vehicle over the ground surface;
an operator platform supported by the frame, and operable to support the weight of a user during operation of the lawn mower;
a utility device coupled to the frame;
three or more battery packs electrically connected to a bus bar and supported by the frame; and
a control system including at least one electronic controller, the control system in communication with the drive motor, the utility device, and the three or more battery packs, the control system configured to:
determine a state of charge for each battery pack of three or more battery packs of the utility vehicle;
determine a first battery pack having a highest state of charge of the three or more battery packs and a second battery pack having a second highest state of charge of the three or more battery packs,
initiate converter battery balancing to discharge the first battery pack to each other battery pack of the three or more battery packs through a DC-to-DC converter in response to at least one selected from the group of:
determining that the state of charge of the first battery pack is more than a first threshold amount above the state of charge of the second battery pack, and
determining that the state of charge of the first battery pack is within a second threshold amount of the state of charge of the second battery pack; and
initiate direct battery balancing, by the control system, to discharge the first battery pack to the second battery pack in response to determining that the state of charge of the first battery pack is between the first threshold amount and the second threshold amount above the state of charge of the second battery pack.

28. The utility vehicle of claim 27, wherein the control system is further configured to:
initiate the direct battery balancing by enabling a bypass positioned between the first and second battery packs to connect the first and second battery packs, and disabling the DC-to-DC converter; and
initiate the converter battery balancing by disabling the bypass.

29. The utility vehicle of claim 27, wherein the control system is further configured determine whether safety constraints of the utility vehicle are satisfied as a precondition to initiating the converter battery balancing or the direct battery balancing.
